(19) United States
(12) Patent Application Publication
(10) Pub. No.: US 2013/0194975 A1
(43) Pub. Date: Aug. 1, 2013

(54) Switch Table Update using Demotion Command in PRIME

(71) Applicant: Texas Instruments Incorporated, Dallas, TX (US)

(72) Inventors: Ramanuja Vedantham, Allen, TX (US); Kumaran Vijayasankar, Dallas, TX (US); Ramachandran Ananthakrishnan, Richardson, TX (US); Robert Liang, Frisco, TX (US)

(73) Assignee: TEXAS INSTRUMENTS INCORPORATED, Dallas, TX (US)

(21) Appl. No.: 13/749,486

(22) Filed: Jan. 24, 2013

Related U.S. Application Data
(60) Provisional application No. 61/590,975, filed on Jan. 26, 2012.

(51) Int. Cl. H04L 12/24

(52) U.S. Cl. 370/255

(57) ABSTRACT

Embodiments of methods and systems for switch table update using demotion command in PRIME are presented. In one embodiment, the method is performed by a power line communication (PLC) device. For example, the PLC device may be a data concentrator. In such an embodiment, the method may include receiving a request for registration from a node in a PLC network. The method may also include determining whether the node was previously included in the network according to an alternate network topology configuration. Additionally, the method may include issuing a notification to a group of switch nodes in the network instructing the switch nodes to update respective switch tables in response to a determination that the node was previously included in the network according to an alternate network topology configuration.

### CROSS-REFERENCE TO RELATED APPLICATION

This application claims the benefit of the filing date of U.S. Provisional Patent Application No. 61/590,975, which is titled “Switch Table Update using Demotion Command in PRIME” and was filed on Jan. 26, 2012, the disclosure of which is hereby incorporated by reference herein in its entirety.

### BACKGROUND

Power line communications (PLC) include systems for communicating data over the same medium that is also used to transmit electric power to residences, buildings, and other premises, such as wires, power lines, or other conductors. In its simplest terms, PLC modulates communication signals over existing power lines. This enables devices to be networked without introducing any new wires or cables. This capability is extremely attractive across a diverse range of applications that can leverage greater intelligence and efficiency through networking. PLC applications include utility meters, home area networks, lighting, and solar.

Using PLC to communicate with utility meters enable applications such as Automated Meter Reading (AMR) and Automated Meter Infrastructure (AMI) communications without the need to install additional wires. Consumers may also use PLC to connect home electric meters to an energy monitoring device or in-home display monitor their energy consumption and to leverage lower-cost electric pricing based on time-of-day demand.

As the home area network expands to include controlling home appliances for more efficient consumption of energy, OEMs may use PLC to link these devices and the home network. PLC may also support home and industrial automation by integrating intelligence into a wide variety of lighting products to enable functionality such as remote control of lighting, automated activation and deactivation of lights, monitoring of usage to accurately calculate energy costs, and connectivity to the grid.

PLC may also serve as an important enabling technology for the mass deployment of solar equipment by providing a communication channel to solar inverters for monitoring and managing power across the grid by utility companies. While radio frequency (RF) communications have made some progress in solar installations, PLC offers an ideal means for connecting equipment with high reliability and at a low cost on DC or AC lines.

PLC is a generic term for any technology that uses power lines as a communications channel. Various PLC standardization efforts are currently in work around the world. The different standards focus on different performance factors and issues relating to particular applications and operating environments. Two of the most well-known PLC standards are G3 and PRIME. G3 has been approved by the International Telecommunication Union (ITU). IEEE is developing the IEEE P1901.2 standard that is based on G3. Each PLC standard has its own unique characteristics.

The manner in which PLC systems are implemented depends upon local regulations, characteristics of local power grids, etc. The frequency band available for PLC users depends upon the location of the system. In Europe, PLC bands are defined by the CENELEC (European Committee for Electrotechnical Standardization). The CENELEC-A band (3 kHz-95 kHz) is exclusively for energy providers. The CENELEC-B, C, D bands are open for end user applications, which may include PLC users. Typically, PLC systems operate between 35-90 kHz in the CENELEC A band using 36 tones spaced 1.5675 kHz apart. In the United States, the FCC has conducted emissions requirements that start at 535 kHz and therefore the PLC systems have an FCC band defined from 154-487.5 kHz using 72 tones spaced at 4.6875 kHz apart. In other parts of the world different frequency bands are used, such as the Association of Radio Industries and Businesses (ARIB)-defined band in Japan, which operates at 10-450 kHz, and the Electric Power Research Institute (EPRI)-defined bands in China, which operates at 3-90 kHz.

### SUMMARY

Embodiments of methods and systems for switch table update using demotion command in PRIME are presented. In one embodiment, the method is performed by a power line communication (PLC) device. For example, the PLC device may be a data concentrator. In such an embodiment, the method may include receiving a request for registration from a node in a PLC network. The method may also include determining whether the node was previously included in the network according to an alternate network topology configuration. Additionally, the method may include issuing a notification to a group of switch nodes in the network instructing the switch nodes to update respective switch tables in response to a determination that the node was previously included in the network according to an alternate network topology configuration.

In one embodiment, the notification is sent in response to receiving the request for registration from the node. Alternatively, the notification may be sent in response to completion of a registration process for registering the node in the PLC network. The notification may include a demotion command. In a further embodiment, the demotion command includes a DEM_REQ_B command according to a PRIME mode of operation.

Another embodiment of a method performed by a PLC device is described. In one embodiment, the PLC device is a switch node. The method may include detecting a request from a node in a switchable path to become a switch node. The method may also include updating a switching table associated with the switchable path to include information associated with the node in response to the request. Additionally, the method may include receiving a notification to remove the information associated with the node from the switching table. The method may also include removing the information associated with the node from the switching table in response to the notification.

In one embodiment, the request to become a switch node comprises a promotion request. The notification to remove the information associated with the node may include a demotion command. The demotion command may be a DEM_REQ_B command according to a PRIME mode of operation.

In one embodiment, the method may include passing the notification to a downstream switch node in a chain of switch nodes. The notification may be received from a data concentrator. Alternatively, the notification is received from an upstream switch node in a chain of switch nodes. In a further embodiment, the notification is received from through an upstream switch node from a data concentrator.

Embodiments of PLC systems are also presented. In one embodiment, the PLC system may include a plurality of PLC network nodes, at least one of which is classified as a switch node configured to store a switch table having information related to a topology of the plurality of PLC network nodes. Additionally, the system may include a data concentrator coupled to the plurality of PLC network nodes. The data concentrator may be configured to receive a request for registration from a node in the PLC network, determine whether the node was previously included in the network according to an alternate network topology configuration, and issue a notification to a group of switch nodes in the network instructing the switch nodes to update respective switch tables in response to a determination that the node was previously included in the network according to an alternate network topology configuration. The system may also include a switch node coupled to the data concentrator. The switch node may be configured to detect a request from a node in a switchable path to become a switch node, update a switching table associated with the switchable path to include information associated with the node in response to the request, receive the notification to remove the information associated with the node from the switching table, and remove the information associated with the node from the switching table in response to the notification.

In one embodiment, the request to become a switch node comprises a promotion request. The notification to remove the information associated with the node may include a demotion command. The demotion command may include a DEM_REQ_B command according to a PRIME mode of operation.

In one embodiment, the switch node is configured to pass the notification to a downstream switch node in a chain of switch nodes. The notification may be received from the data concentrator. Alternatively, the notification may be received from an upstream switch node in a chain of switch nodes. In a further embodiment, the notification is received from through an upstream switch node from a data concentrator.

In one embodiment, the notification is sent in response to receiving the request for registration from the node. In a further embodiment, the notification is sent in response to completion of a registration process for registering the node in the PLC network.

In some embodiments, one or more of the methods described herein may be performed by one or more PLC devices (e.g., a PLC meter, PLC data concentrator, etc.). In other embodiments, a tangible electronic storage medium may have program instructions stored thereon that, upon execution by a processor within one or more PLC devices, cause the one or more PLC devices to perform one or more operations disclosed herein. Examples of such a processor include, but are not limited to, a digital signal processor (DSP), an application specific integrated circuit (ASIC), a system-on-chip (SoC) circuit, a field-programmable gate array (FPGA), a microprocessor, or a microcontroller. In yet other embodiments, a PLC device may include at least one processor and a memory coupled to the at least one processor, the memory configured to store program instructions executable by the at least one processor to cause the PLC device to perform one or more operations disclosed herein.

### BRIEF DESCRIPTION OF THE DRAWINGS

Having thus described the invention(s) in general terms, reference will now be made to the accompanying drawings, wherein:

FIG. 1 is a diagram of a PLC system according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a block diagram illustrating one embodiment of a PLC network switching topology.

FIG. 6 is a block diagram illustrating another embodiment of a PLC network switching topology.

FIG. 7 is a block diagram illustrating a method for updating switch tables.

FIG. 8 is a block diagram illustrating an embodiment of a PLC network with updated switch tables.

FIG. 9 is a flowchart diagram illustrating one embodiment of a method for updating switch tables.

FIG. 10 is a block diagram of an integrated circuit according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

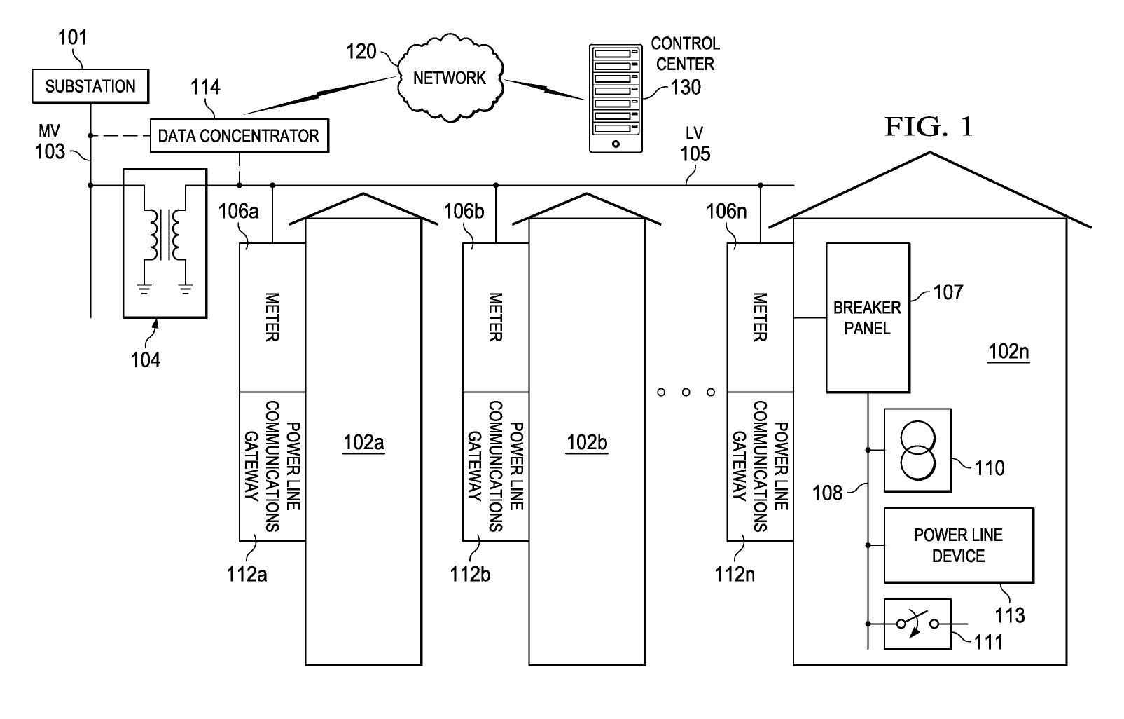

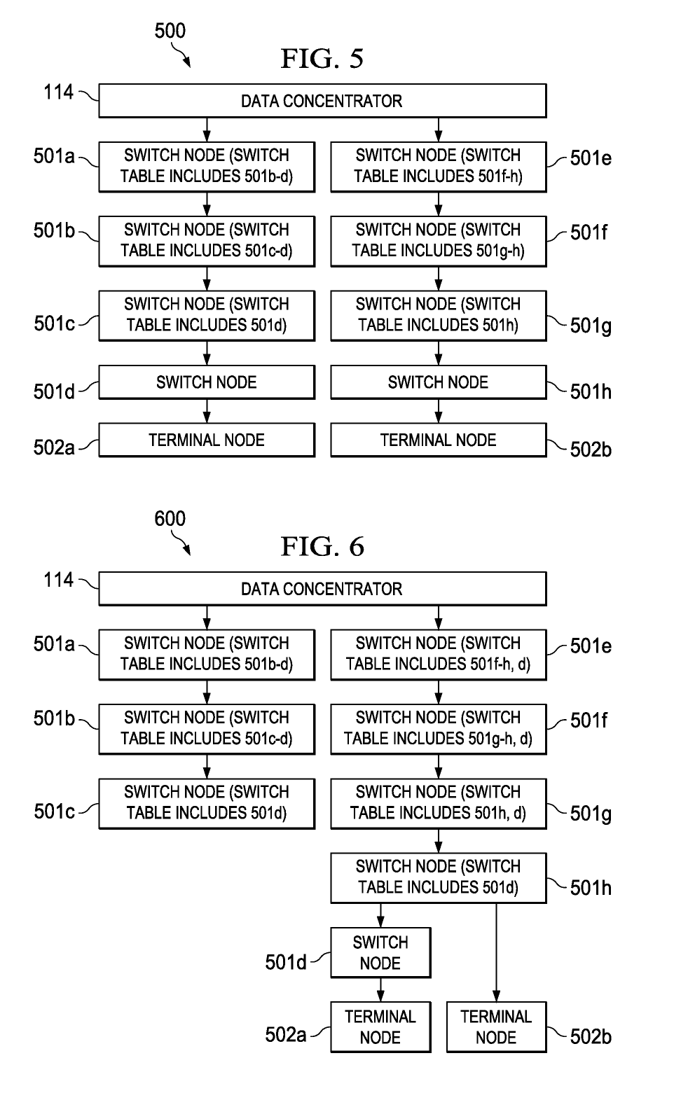

The PRIME standard requires that each switch node maintain the list of all switch nodes connected directly or indirectly to it. Embodiments of the present invention are directed using a notification, such as a demotion message (DEM_REQ_B), to pro-actively demote the switch node through a switch path to clear the entry corresponding to switch node which has left the path, instead of waiting for a “keep alive” timeout to expire. An example of such a system is described below in FIGS. 5-8. FIGS. 1-4 describe the systems and methods generally.

FIG. 1 illustrates a PLC system according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. Although referred to as “residences,” premises 102a-n may include any type of building, facility, electric vehicle charging station, or other location where electric power is received and/or consumed. A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use a carrier signal having a frequency different from that of the power signal. The carrier signal may be modulated by the data, for example, using an OFDM technology or the like described, for example, by the PRIME, G3 or IEEE 1901 standards.

PLC modems or gateways 112a-n at residences 102a-n use the MV/LV power grid to carry data signals to and from PLC data concentrator or router 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more PLC data concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

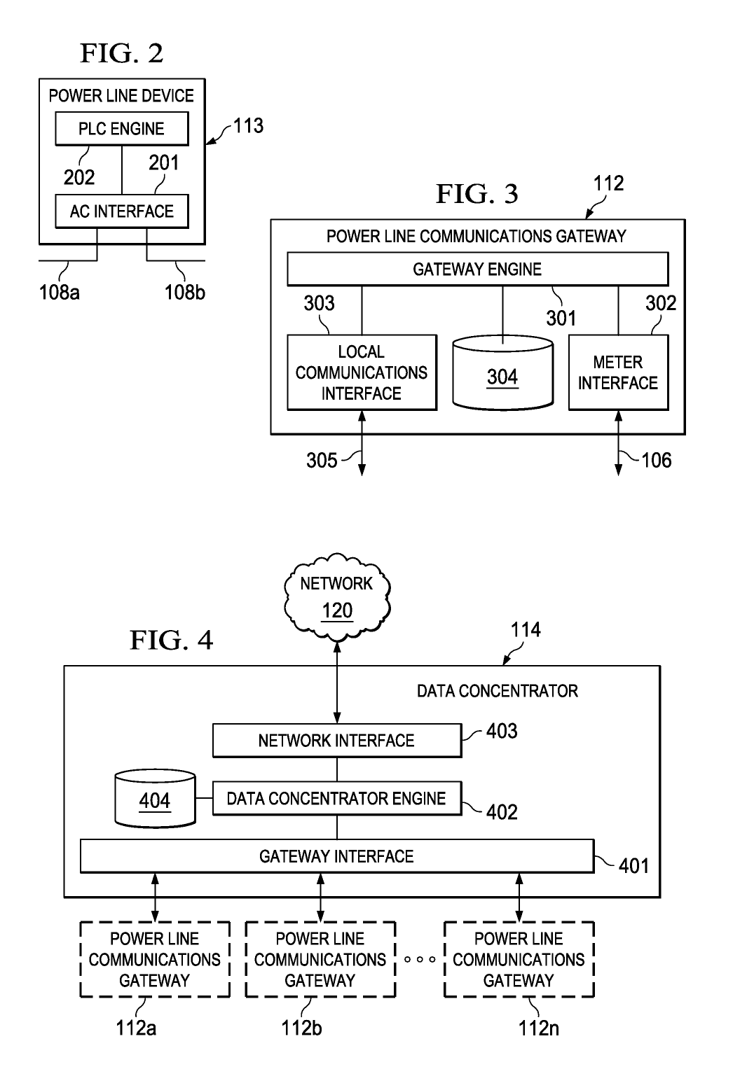

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZIGBEE, BLUETOOTH, WI-FI, WI-MAX, ETHERNET, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 305 in assigning, allocating, or otherwise managing frequency bands assigned to its various PLC devices.

FIG. 4 is a block diagram of PLC data concentrator or router 114 according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

FIG. 5 illustrates an example of a topology for a PLC network 500. In such an embodiment, the PLC network 500 may include a data concentrator 114. The data concentrator may be coupled to one or more network nodes. In one embodiment, the network topology may be arranged in a switch/terminal configuration, where a node is classified as a switch node 501 if it has one or more downstream nodes coupled to it, and a node is classified as a terminal node 502 if it does not have any downstream nodes coupled to it. A node may include additional data concentrators 114, PLC communication gateways 112, and/or PLC devices 113. In a further embodiment, additional network elements, including meters 106 and other devices may be configured as nodes as well.

In the example of FIG. 5, the network 500 includes a data concentrator 114, a plurality of switch nodes arranged in two separate chains or streams. For example, the first chain may include four switch nodes 501a-d and a terminal node 502a, and the second chain may also include four switch nodes 201e-h and a terminal node 502b. Communications may be passed from the data concentrator 114 to any one of the nodes in the network. For example, data concentrator may send a message to the first terminal node 502a through the first chain. In such an embodiment, the message will be passed through each of the switch nodes 501a-d.

In more complex topologies, it may be necessary to determine a correct path tot eh terminal node. For this reason, each of the switch nodes 501 may store a switch table which includes information about each downstream switch node 501 coupled either directly or indirectly to it. For example, the first switch node 501a may include a switch table that includes identification information and/or routing information for each of its downstream switch nodes 501b-d. Similarly, the first switch node 501e in the second chain may include a switch table that includes information regarding each of its downstream switch nodes 501f-h.

In an alternative embodiment, the switch nodes may be configured to store a switch table that includes information about upstream nodes. For example, switch node 501d may include an upstream switch table which includes information about switch nodes 501a-c. In one embodiment, the switch tables do not include information regarding terminal nodes 502a-b. In an alternative embodiment, the switch tables may include the information regarding terminal nodes 502a-b. One of ordinary skill in the art will recognize several different switch table configurations which may be advantageous in light of the present embodiments.

In some embodiments, network topologies may change for various reasons. For example, a PLC device may lose power or may be reconfigured or repositioned within the network. FIG. 6 illustrates an alternative topology. Network 600 shows an embodiment in which switch node 501d is moved to the second chain and coupled to switch node 501h. In such an embodiment, switch node 501d may perform a registration process which updates each of the switch tables in the second chain to include switch node 501d. Although the switch tables in the second chain are updated, the original switch tables in the first chain may remain unchanged until a timeout period expires. The timeout period may be defined by a value of a Keep Alive timer. In certain embodiments, the timeout period may be quite long; therefore the switch tables of the first chain may include stale or inaccurate data for significant periods of time. This inaccuracy could result in faults or failures to route messages properly. Additionally, the stale information may occupy valuable space in the switch table. Given that prime switch nodes are memory limited, removing such stale information in time can help improve performance significantly.

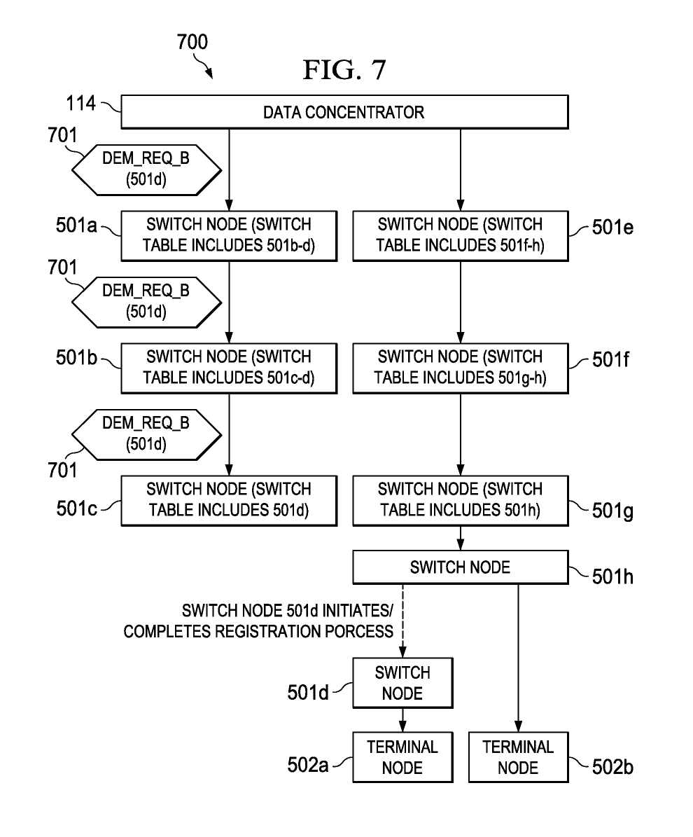

FIG. 7 illustrates a method for removing stale information in the switch tables by an update notification. In one embodiment, the update notification is initiated by the data concentrator 114 in response to receiving a registration request from a previously known node. For example, as illustrated in network 700, switch node 501d may initiate a registration process with data concentrator 114. In one embodiment, the data concentrator 114 may issue a notification to the switch nodes 501a-c in the first chain indicating that 501d is to be removed from the switch table of each of the switch nodes 501a-c in the first chain. In an alternative embodiment, the data concentrator 114 may issue the notification in response to completion of the registration process. In one embodiment, the notification may include a demotion command. For example, in PRIME, the data concentrator 114 may issue a DEM_REQ_B command 701 as illustrated in FIG. 7. One of ordinary skill may recognize alternative notifications that may be suitable for use with the present embodiments.

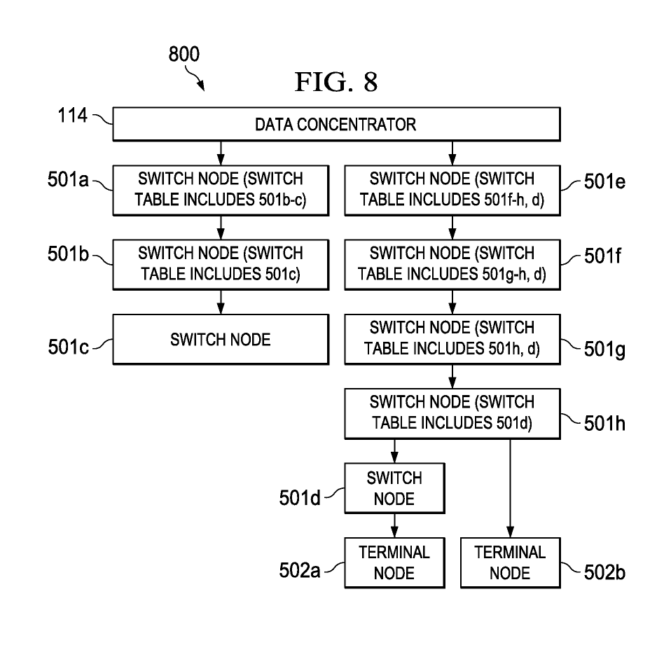

Upon completion of the method described in FIG. 7, network 800 having the topology illustrated in FIG. 8 may be configured. In this embodiment, switch node 501d is coupled to switch node 501h, and the switch table of each of the switch nodes 501a-h reflects accurate information regarding node 501d in response to the registration process of switch node 501d with the date concentrator 114. In one embodiment, the switch table updates may occur during or immediately following switch node 501d registering with the data concentrator 114.

The embodiments may be standard compliant and hence may not require any changes to the service node implementation. The embodiments help remove stale information quickly thereby helping improve network performance.

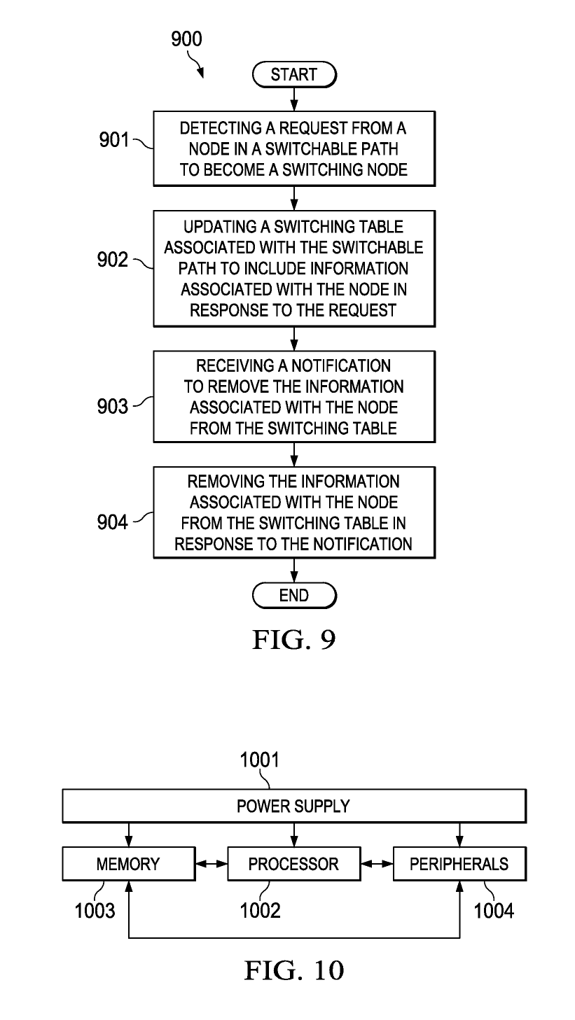

FIG. 9 illustrates an embodiment of the method conducted by each of switch nodes 501a-h. In one embodiment, the method 900 starts when the switch nodes 501a-h detect 901 a request from a node in a switchable path to become a switch node. Each switch node in the path 501a-c or 501e-h may then update 902 a switching table associated with the switchable path to include information associated with the node in response to the request. In one embodiment, the switch node may then receive 903 a notification to remove the information associated with node from the switch table. In response to receiving 903 the notification, the switch node may then remove 904 the information associated with the node from the switching table in response to the notification.

FIG. 10 is a block diagram of a circuit for implementing co-existence between PLC devices according to some embodiments. In some cases, one or more of the devices and/or apparatuses shown in FIGS. 1-4 may be implemented as shown in FIG. 10. In some embodiments, processor 1002 may be a digital signal processor (DSP), an application specific integrated circuit (ASIC), a system-on-chip (SoC) circuit, a field-programmable gate array (FPGA), a microprocessor, a microcontroller, or the like. Processor 1002 is coupled to one or more peripherals 1004 and external memory 1003. In some cases, external memory 1003 may be used to store and/or maintain databases 304 and/or 404 shown in FIGS. 3 and 4. Further, processor 1002 may include a driver for communicating signals to external memory 1003 and another driver for communicating signals to peripherals 1004. Power supply 1001 provides supply voltages to processor 02 as well as one or more supply voltages to memory 1003 and/or peripherals 1004. In some embodiments, more than one instance of processor 1002 may be included (and more than one external memory 1003 may be included as well).

Peripherals 1004 may include any desired circuitry, depending on the type of PLC system. For example, in an embodiment, peripherals 1004 may implement local communication interface 303 and include devices for various types of wireless communication, such as WI-FI, ZIGBEE, BLUETOOTH, cellular, global positioning system, etc. Peripherals 1004 may also include additional storage, including RAM storage, solid-state storage, or disk storage. In some cases, peripherals 1004 may include user interface devices such as a display screen, including touch display screens or multi-touch display screens, keyboard or other input devices, microphones, speakers, etc.

External memory 1003 may include any type of memory. For example, external memory 1003 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 1003 may include one or more memory modules to which the memory devices are mounted, such as single inline memory modules (SIMMs), dual inline memory modules (DIMMs), etc.

It will be understood that in various embodiments, the modules shown in FIGS. 2-4 may represent sets of software routines, logic functions, and/or data structures that are configured to perform specified operations. Although these modules are shown as distinct logical blocks, in other embodiments at least some of the operations performed by these modules may be combined in to fewer blocks. Conversely, any given one of the modules shown in FIGS. 2-4 may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method comprising:
performing, by a power line communication (PLC) device,
receiving a request for registration from a node in a PLC network;
determining whether the node was previously included in the network according to an alternate network topology configuration; and
issuing a notification to a group of switch nodes in the network instructing the switch nodes to update respective switch tables in response to a determination that the node was previously included in the network according to an alternate network topology configuration.

2. The method of claim 1, wherein the notification is sent in response to receiving the request for registration from the node.

3. The method of claim 1, wherein the notification is sent in response to completion of a registration process for registering the node in the PLC network.

4. The method of claim 1, wherein the notification comprises a demotion command.

5. The method of claim 4, wherein the demotion command comprises a DEM REQ B command according to a PRIME mode of operation.

6. A method comprising:
performing, by a power line communication (PLC) device,
detecting a request from a node in a switchable path to become a switch node;
updating a switching table associated with the switchable path to include information associated with the node in response to the request;
receiving a notification to remove the information associated with the node from the switching table; and
removing the information associated with the node from the switching table in response to the notification.

7. The method of claim 6, wherein the request to become a switch node comprises a promotion request.

8. The method of claim 6, wherein the notification to remove the information associated with the node comprises a demotion command.

9. The method of claim 8, wherein the demotion command comprises a DEM_REQ_B command according to a PRIME mode of operation.

10. The method of claim 6, further comprising passing the notification to a downstream switch node in a chain of switch nodes.

11. The method of claim 6, wherein the notification is received from a data concentrator.

12. The method of claim 6, wherein the notification is received from an upstream switch node in a chain of switch nodes.

13. The method of claim 6, wherein the notification is received from through an upstream switch node from a data concentrator.

14. A PLC system comprising:
a plurality of PLC network nodes, at least one of which is classified as a switch node configured to store a switch table having information related to a topology of the plurality of PLC network nodes;
a data concentrator coupled to the plurality of PLC network nodes, and configured to:
receive a request for registration from a node in the PLC network;
determine whether the node was previously included in the network according to an alternate network topology configuration; and
issue a notification to a group of switch nodes in the network instructing the switch nodes to update respective switch tables in response to a determination that the node was previously included in the network according to an alternate network topology configuration; and
the switch node coupled to the data concentrator, the switch node configured to:
detect a request from a node in a switchable path to become a switch node;
update a switching table associated with the switchable path to include information associated with the node in response to the request;
receive the notification to remove the information associated with the node from the switching table; and
remove the information associated with the node from the switching table in response to the notification.

15. The PLC system of claim 14, wherein the request to become a switch node comprises a promotion request.

16. The PLC system of claim 14, wherein the notification to remove the information associated with the node comprises a demotion command.

17. The PLC system of claim 16, wherein the demotion command comprises a DEM_REQ_B command according to a PRIME mode of operation.

18. The PLC system of claim 14, further comprising passing the notification to a downstream switch node in a chain of switch nodes.

19. The PLC system of claim 14, wherein the notification is received from a data concentrator.

20. The PLC system of claim 14, wherein the notification is received from an upstream switch node in a chain of switch nodes.

21. The PLC system of claim 14, wherein the notification is received from through an upstream switch node from a data concentrator.

22. The PLC system of claim 14, wherein the notification is sent in response to receiving the request for registration from the node.

23. The PLC system of claim 14, wherein the notification is sent in response to completion of a registration process for registering the node in the PLC network.
